(19) United States
(12) Patent Application Publication
(10) Pub. No.: US 2008/0307921 A1
(43) Pub. Date: Dec. 18, 2008

(54) Activation Device for Controlling the Power of a Vehicle Drive Having a Foot Pedal

(75) Inventors: Tan-Phat La, Altdorf (DE); Andreas Meyer, Stuttgart (DE); Martin Mueller, Friolzheim (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart Germany (DE)

(21) Appl. No.: 11/666,281

(22) PCT Filed: Oct. 18, 2005
(86) PCT No.: PCT/EP05/11177

§ 371 Date: Feb. 27, 2008

(30) Foreign Application Priority Data
Oct. 26, 2004 (DE) 10-2004-051-888.2

(51) Int. Cl. G05G 1/30; G06F 17/00; F16H 59/20; F02D 11/10

(52) U.S. Cl. 74/513; 701/93

(57) ABSTRACT

In an activation device for controlling the power of a vehicle drive having a foot pedal, in which the foot pedal is pivotably mounted such that it can abut against a rigid end stop, a switching element which can be displaced by the pivoting movement of the foot pedal is mounted ahead of the end stop in the pivoting path of the foot pedal. The displacement of the switching element requires a reaction force which originates from the switching element to be overcome. The intention is to prevent or reduce a possible abutting noise which can occur when the foot pedal impacts on the switching element at a high impact speed. The device includes a spring element connected ahead of the switching element in the pivoting path of the foot pedal. The spring force of the spring element is less than the reaction force originating from the switching element for a displacement by the foot pedal.

### CROSS REFERENCE TO RELATED APPLICATIONS

This application is a national stage of PCT International Application No. PCT/EP2005/011177, filed Oct. 18, 2005, which claims priority under 35 U.S.C. § 119 to German Patent Application No. 10 2004 051 888.2, filed Oct. 26, 2004, the entire disclosures of which are herein expressly incorporated by reference.

### BACKGROUND AND SUMMARY OF THE INVENTION

The present invention relates to an activation device for controlling the power of a vehicle drive having a foot pedal.

Such a device is known, for example, from German patent document DE 102 12 904 A1. In the disclosed device, the reaction force of the switching element, which has to be overcome for the switching element (which is acted on by the foot pedal) to switch, is generated by a spring which is integrated into the switching element.

In another known device according to German patent document DE 195 00 666 C2, an elastically deformable element, which has to be elastically deformed just before the foot pedal strikes the rigid stop, is provided outside the rigid stop. The switching element disclosed in this document has a position signal transmitter provided on the pivoting axis of the foot pedal. The position signal transmitter triggers a switching signal as soon as the foot pedal strikes the rigid stop. In contrast to the device according to the first-mentioned document, the switching element here is not activated by the foot pedal abutting against the switching element. The switching element here has a position signal transmitter which detects the angular position of the foot pedal on the axis of the foot pedal and activates the switching element at a predetermined angular position.

The switching element which the invention and the two abovementioned documents relate to is known in practice as a kickdown switching element, which is also referred to as a kickdown button.

In a device of the generic type according to German patent document DE 102 12 904 A1, the device is concerned with the problem of damping (i.e., reducing) the impacting noise of the foot pedal which impacts on the switching element. Such an impacting noise occurs in the known device if an operator activates the foot pedal extremely quickly for a kickdown acceleration.

This problem is solved in a device according to exemplary embodiments of the present invention which are based on the general idea of connecting a sprung damping element in front of the switching element on which the foot pedal directly impacts. In this context it is important for the function of such a damping element that the damping travel up to the time when the foot pedal abuts against the switching element remains exactly the same and does not experience any change during the operating time of a vehicle. This is important because the power control of the vehicle drive which has its origin in the foot pedal is based on precisely predefined angular positions of the foot pedal, or these angular positions have to be maintained unconditionally for the function to remain constant.

For example, damping elements such as felt layers or elastically deformable cushions are unsuitable, because they generally change their spring compression travel length over long operating times. Such changes are, on the one hand, conditioned by deformation of materials, and on the other hand, are dependent on wear of such elastic materials which is generally impossible to avoid.

In one exemplary embodiment of the present invention, when the damping spring reaches its maximum spring compression travel the damping spring dips completely into the surface of the switching element on which the foot pedal impacts with damping by the spring. As a result, the displacement of the switching element, which is dependent on the pivoting angle of the foot pedal and is brought about by the foot pedal which bears directly against the switching element, remains independent of the shape and position of the damping spring according to the invention.

The refinement of a spring according to the invention which is expediently composed of spring steel is particularly advantageously in the form of an angle at which the two angular webs include an obtuse angle between them. The angular web, which is not tightly secured to the switching element, protrudes obliquely from the impact face of the switching element for the foot pedal with such a design of the spring. The protruding angle can be, for example, approximately 30 degrees.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a perspective view of an activation device according to an exemplary embodiment of the invention having a foot pedal and a switching element activated by the latter, within a rigid stop,

FIG. 2 shows a perspective view of the switching element having a damping spring which is integrated into it,

FIG. 3 shows a perspective view of the damping spring which is inserted into the switching element according to FIG. 2 and is in the form of a spring angle,

FIGS. 4a-e show various foot pedal positions between a non-activated foot pedal and a foot pedal which is in a completely activated kickdown position.

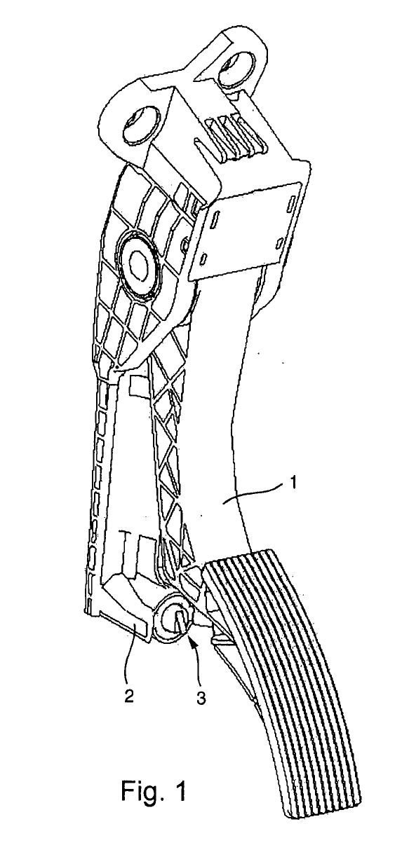

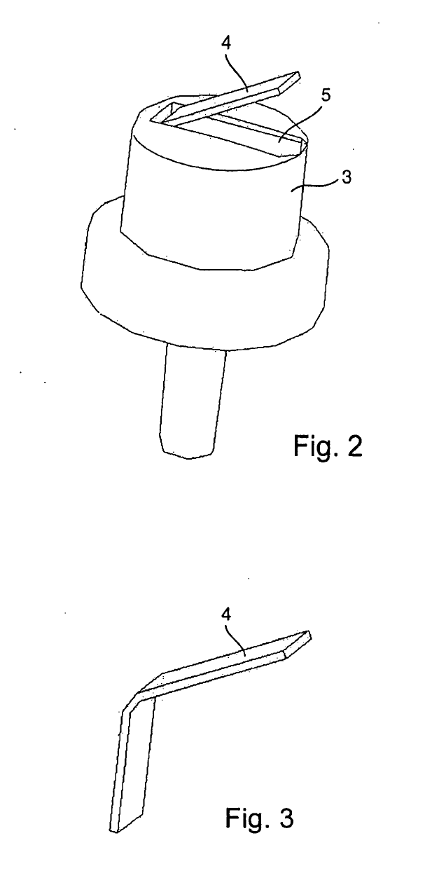

### DETAILED DESCRIPTION OF THE DRAWINGS

An activation operation in order to control the power of a vehicle drive includes a foot pedal 1 which is pivotable and is secured to the vehicle, and a rigid stop 2 as a pivoting travel limiter for the foot pedal 1.

A switching element 3 is mounted ahead of the rigid stop 2 within the pivoting travel of the foot pedal 1. In this context, this switching element 3 is mounted in a pliant fashion within the rigid stop 2, specifically in such a way that when the foot pedal 1 impacts on the rigid stop 2 the switching element 3 is pushed into the interior of the rigid stop 2 by an exactly predefined amount of travel. In practice, the switching element 3 is usually referred to as a kickdown button. This switching element 3 can be embodied in a known, customary fashion with kickdown buttons.

A damping spring 4 is provided within the impact face of the switching element 3 for the stop of the foot pedal 1.

As is apparent from FIG. 3, the spring 4 is in the form of an angle in which angular webs which adjoin one another include an obtuse angle between them. In particular, a customary spring steel is suitable as the material for the spring 4.

The spring 4 is attached in the switching element 3 by virtue of the fact that a first of the two angular webs is secured in it, in which case the first angular web engages completely in the switching element 3. The second angular web projects obliquely from the impact face of the switching element 1 and in doing so has, for example, an angle of inclination of approximately 30 degrees.

In the switching element 3, the spring 4 is mounted within a groove 5 in such a way that the sprung angular web, which protrudes in an inclined fashion, can be completely accommodated in this groove 5 when the foot pedal 1 abuts completely. Completely accommodated means that when the foot pedal 1 abuts completely against the switching element 3 only the adjoining surfaces of the switching element 3 and the foot pedal 1 are in “inelastic contact” with one another.

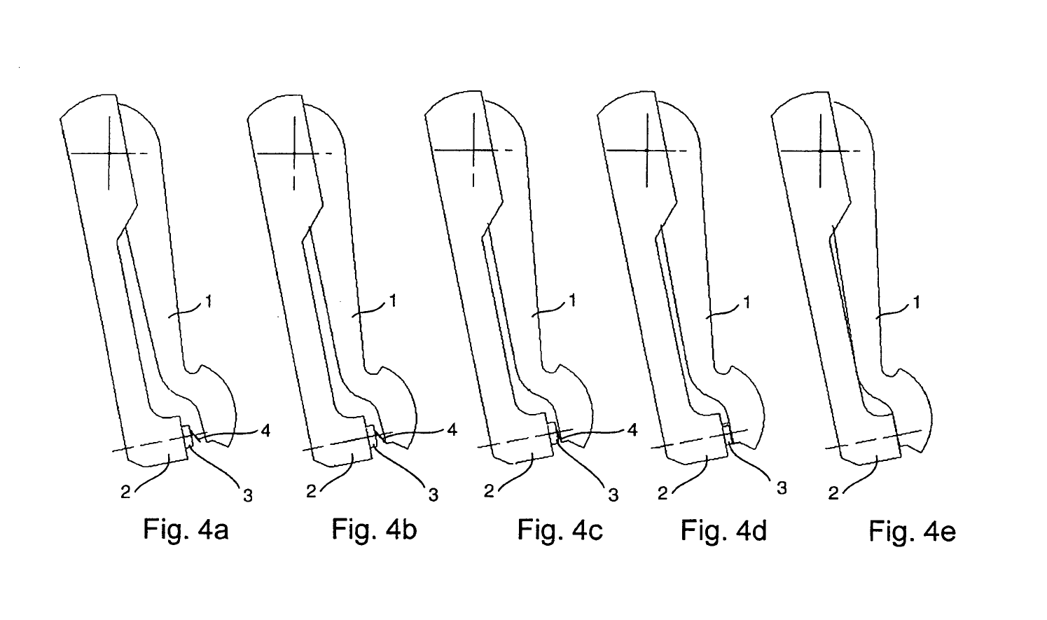

The function of the device according to the invention is, with particular reference to FIG. 4, as follows:

If the foot pedal 1 is depressed (i.e., pivoted) quickly by an operator in the direction of the rigid stop 2 for a kickdown acceleration, the foot pedal 1 impacts on the damping spring 4 provided on the impact face of the switching element 3 before it impacts directly on the impact face (FIG. 4b). As a result, a considerable degree of damping of the impacting noise occurs. The spring force of the spring 4 is configured in such a way that the switching element 3, which can per se be displaced, remains in its initial position up to the time when the foot pedal 1 impacts directly (FIGS. 4a-4d). This means that the reaction force which originates from the switching element 3 in the direction of the foot pedal 1 is greater than the spring force of the damping spring 4. The damping spring 4 can be of any desired shape irrespective of the exemplary embodiment shown. All that is decisive is that there is absolute certainty that the spring 4 retains its spring compression travel when it is acted on by the foot pedal 1 over its entire service life. Even though spring steel is particularly well suited for such a spring 4, other spring materials can, of course, also be used if they meet the requirements which are made here. The position of the foot pedal 1 in the completely activated kickdown state is shown by FIG. 4e, in which the foot pedal 1 bears directly against the rigid end stop 2, with the switching element 3 dipping completely into the stop 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. An activation device for controlling the power of a vehicle drive having a foot pedal that is pivotably mounted such that the foot pedal is abuttable against a rigid end stop, the activation device comprising:
a switching element that is displaceable by pivoting movement of the foot pedal, and is mounted ahead of the end stop in a pivoting path of the foot pedal, such that displacement of the switching element requires that a reaction force originating from the switching element be overcome; and
a spring element connected ahead of the switching element in the pivoting path of the foot pedal;
wherein a spring force of the spring element is less than the reaction force originating from the switching element for a displacement by the foot pedal.

8. The activation device as claimed in claim 7, wherein the spring element is a leaf spring.

9. The activation device as claimed in claim 8, wherein the spring element comprises angle webs which bear against one another at an obtuse angle.

10. The activation device as claimed in claim 9, wherein an angle web of the spring element is secured within the switching element.

11. The activation device as claimed in claim 9, wherein:
one angle web which protrudes freely from the switching element is mounted in the switching element within a groove within the face of the switching element,
the switching element is covered by the foot pedal when abutment occurs, and
the angle web can move into the groove when undergoing complete spring compression travel.

12. The activation device as claimed in claim 7, wherein, when an angle web of the spring element has undergone complete spring compression, a surface of the switching element serves exclusively as a rigid stop face.

13. The activation device as claimed in claim 10, wherein the angle web protrudes freely from the switching element and is mounted in the switching element within a groove within the face of the switching element which is covered by the foot pedal when abutment occurs, into which groove the angle web can move when undergoing complete spring compression travel.

14. The activation device as claimed in claim 8, wherein when an angle web of the spring element has undergone complete spring compression, a surface of the switching element serves exclusively as a rigid stop face.

15. The activation device as claimed in claim 9, wherein, when an angle web of the spring element has undergone complete spring compression, a surface of the switching element serves exclusively as a rigid stop face.

16. The activation device as claimed in claim 10, wherein, when an angle web of the spring element has undergone complete spring compression, a surface of the switching element serves exclusively as a rigid stop face.

17. The activation device as claimed in claim 11, wherein, when an angle web of the spring element has undergone complete spring compression, a surface of the switching element serves exclusively as a rigid stop face.

18. The activation device as claimed in claim 13, wherein, when an angle web of the spring element has undergone complete spring compression, a surface of the switching element serves exclusively as a rigid stop face.

19. A method for controlling the power of a vehicle drive having a foot pedal that is pivotably mounted such that the foot pedal is abuttable against a rigid end stop, the method comprising:
displacing a switching element by pivoting movement of the foot pedal which is mounted ahead of the end stop in a pivoting path of the foot pedal; and
overcoming a reaction force originating from the switching element to achieve displacement of the switching element, wherein
a spring element is connected ahead of the switching element in the pivoting path of the foot pedal; and
a spring force of the spring element is less than the reaction force originating from the switching element for a displacement by the foot pedal.

20. The method as claimed in claim 19, wherein the spring element is a leaf spring.

21. The method as claimed in claim 19, wherein the spring element is comprises angle webs which bear against one another at an obtuse angle.

22. The method as claimed in claim 19, wherein the spring element is secured within the switching element.

23. The method as claimed in claim 19, wherein an angle web which protrudes freely from the switching element is mounted in the switching element within a groove within the face of the switching element which is covered by the foot pedal when abutment occurs, into which groove the angle web can move when undergoing complete spring compression travel.

24. The method as claimed in claim 19, wherein, when an angle web of the spring element has undergone complete spring compression, a surface of the switching element serves exclusively as a rigid stop face.
